(19) United States
(12) Patent Application Publication
(10) Pub. No.: US 2011/0113124 A1
(43) Pub. Date: May 12, 2011

(54) METHOD AND DEVICE FOR DOWNLOADING MULTIMEDIA CONTENTS AT HIGH SPEED IN THE INTERNET

(75) Inventor: Shaohua Zhang, Shanghai (CN)

(73) Assignee: SHANGHAI SYNACAST MEDIA TECH CO., LTD, Shanghai, CN (CN)

(21) Appl. No.: 13/000,610

(22) PCT Filed: Jun. 23, 2009
(86) PCT No.: PCT/CN09/72413

§ 371 Date: Dec. 21, 2010

(30) Foreign Application Priority Data
Jun. 25, 2008 (CN) 200810039592.2

(51) Int. Cl. G06F 15/16

(52) U.S. Cl. 709/219

(57) ABSTRACT

In order to download multimedia content with hidden address information on the Internet to the user terminal, the invention proposes obtaining address information of the multimedia contents to be downloaded with hidden address information in the predetermined multimedia server, when a multimedia player of the user terminal obtains the multimedia contents to be downloaded from the predetermined multimedia server, and obtaining information related to a plurality of network resources comprising the same multimedia contents as the multimedia contents to be downloaded, according to the address information of the multimedia contents to be downloaded in the predetermined multimedia server, then downloading the multimedia contents to be downloaded, according to the information related to the plurality of network resources.

### FIELD OF THE INVENTION

The invention relates to method and device for downloading data in the Internet, in particular relates to the method and device for downloading multimedia contents in the Internet.

### BACKGROUND OF THE INVENTION

With the fast development of the internet technology and the multimedia processing technology currently, the transferring of multimedia contents via the internet becomes easier. Therefore, content service provider provides more and more multimedia contents over the Internet, and more and more users enjoy multimedia contents over the internet. For example, the Adobe Flash Player can play the video contents compressed by video compression standard, such as H.264 standard, Sorenson H. 263 standard or VP6 standard, as well as play the audio contents compressed by the audio compression standard such as MP3 or AAC. Meanwhile, with the progress of the multimedia processing technology, the Adobe company announced that the Adobe Flash Player can support more and more multimedia compression standard. The multimedia contents based on these standards may be included in the Flash Video (FLV for short) file or Flash audio file, and are stored in the multimedia server of the content provider. When the user plays the multimedia contents, he/she uses the Flashplayer provided by the content provider on his/her user terminal, downloads the corresponding Flash video file or Flash audio file comprising the multimedia contents from the multimedia server provided by the content provider, and views the multimedia contents.

Since currently the multimedia contents based on FLV are more and more varied, the users more and more desire to download the FLV freely to the local for viewing at any time. However, the address information of the multimedia contents, including the Uniform Resource Locator (URL), etc, provided by the content provider, is hidden to some extent by the content provider. Common user or ordinary download software can not obtain the URL of the FLV file, and can not download the FLV directly. For example, by the configuration of the Action Script, the Flash player of the content provider requests and downloads FLV files on the multimedia server of the content provider based on HTTP (Hyper Text Transferring Protocol) manner, wherein the HTTP request comprises the URL of the FLV file. However, common user and ordinary download software can not directly obtain the operation information of the action script; therefore they can not obtain the URL of the requested FLV file and can not download the FLV file automatically.

Therefore, in order for the common user to download the multimedia content with hidden address information, for example, the FLV file with hidden URL, to the local, the following two technical problems need to be solved:
1. the address of the FLV file on the server, for example, the URL;
2. download the requested FLV file from the Internet to user's local according to the address.

The existing Realplayer 11 software of the RealNetworks company can obtain the URL of the FLV filed played by the player by that the user runs the FLASH player of the content provider. And then, the Realplayer 11 downloads the FLV file to the location designated by the user terminal from the multimedia server corresponding to the URL in a C/S manner. However, the download of the current Realplayer 11 is restricted to C/S mode, the source of the download of the file only comprises the multimedia server corresponding to the URL.

It could be seen that the prior art can obtain the FLV so as to solve the abovementioned technical problem 1. As for the technical problem 2, the prior art only relies on the “try best” of the C/S downloading mode and the speed of the download cannot be guaranteed.

### SUMMARY OF THE INVENTION

In order to solve both the technical problems 1 and 2 simultaneously, the present invention proposes: first obtaining the address information of the multimedia content, and then obtaining the information related to network resources that comprises the multimedia contents same as the multimedia contents according to the address information, and at last downloading the multimedia contents according to information related to the plurality of network resources.

To be specific, according to a first aspect of the present invention, there is provided a downloading method of downloading multimedia contents to be downloaded from the network to the local user terminal, wherein a predetermined multimedia server comprises the multimedia contents to be downloaded, the address information of the multimedia contents to be downloaded in the multimedia server is hidden, the method comprises the steps of: i. obtaining address information of the multimedia contents to be downloaded in the predetermined multimedia server, when a multimedia player of the user terminal obtains the multimedia contents to be downloaded from the predetermined multimedia server; ii. obtaining information related to a plurality of network resources comprising the same multimedia contents as the multimedia contents to be downloaded, according to the address information of the multimedia contents to be downloaded in the predetermined multimedia server; iii. downloading the multimedia contents to be downloaded, according to the information related to the plurality of network resources.

According to a second aspect of the present invention, there is provided an assisting download method, in a first network server, for assisting the user terminal to download the multimedia contents from the network to the user terminal with high speed, wherein the predetermined multimedia server comprises the multimedia contents to be downloaded, the address information of the multimedia contents to be downloaded on the predetermined multimedia server is hidden, the assisting download method comprises: o. receiving the address information of the multimedia contents to be downloaded in the predetermined multimedia server from the user terminal; p. obtaining the information related to the multimedia contents according to the address information of the multimedia contents to be downloaded on the predetermined multimedia server; q. providing the information related to the multimedia contents to the user terminal.

According to a third aspect of the present invention, there is provided an assisting downloading method, in a second network server, for assisting a user terminal to download multimedia contents to be downloaded from the network with high speed, wherein a predetermined multimedia server comprises the multimedia contents to be downloaded, and the address information of the multimedia contents to be downloaded in the predetermined multimedia server is hidden, the assisting downloading method comprises: I. receiving, from the user terminal, candidate content identification information and the node related information of the user terminal, wherein contents corresponding to the candidate content identification information are the same as the multimedia contents to be downloaded; II. obtaining the information related to other user terminal nodes that have piece of the contents corresponding to the candidate content identification information, according to the candidate content identification information; III. sending, to the user terminal, the information related to other user terminal nodes that have piece of the contents corresponding to the candidate content identification information.

According to a fourth aspect of the present invention, there is provided a downloading device for downloading multimedia contents to be downloaded from the network to the local user terminal, wherein a predetermined multimedia server comprises the multimedia contents to be downloaded, the address information of the multimedia contents to be downloaded in the multimedia server is hidden, the downloading device comprises: a means for obtaining address information, for obtaining address information of the multimedia contents to be downloaded in the predetermined multimedia server, when a multimedia player of the user terminal obtains the multimedia contents to be downloaded from the predetermined multimedia server; means for obtaining network resources, for obtaining information related to a plurality of network resources comprising the same multimedia contents as the multimedia contents to be downloaded, according to the address information of the multimedia contents to be downloaded in the predetermined multimedia server; downloading means, for downloading the multimedia contents to be downloaded, according to the information related to the plurality of network resources.

With the method or device according to the present invention, it can achieve the following advantages:

1. the address information of the multimedia contents to be downloaded with hidden address information accurately;

2. the multimedia content can be obtained simultaneously from a plurality of network resources according to the address information, and the download speed for the multimedia content is greatly improved.

### BRIEF DESCRIPTION OF THE DRAWINGS

The features, objects and advantages of the present invention will be easily understood by reading the detailed description of the non-limiting embodiments with reference to the drawings. Wherein, same or similar reference signs represent same or similar element (device).

FIG. 1 is a schematic view of the network wherein a user terminal 10 requests to download a Flash video on a multimedia server 20, according to an embodiment of the invention.

FIG. 2 shows the flowchart of downloading method that the user terminal 10 downloads a Flash video from the network to the user terminal according to an embodiment of the invention.

FIG. 3 is a schematic view of the network wherein the user terminal 10 obtains the Flash video from a plurality of user terminal nodes under the assistance from a first network server 30 and a second network server 40, according to an embodiment of the present invention.

FIG. 4 is a flowchart of the method that the user terminal 10 obtains content identification information corresponding to the URL of the Flash video on the multimedia server 20 under the assistance from the first network server 30, according to an embodiment of the present invention.

FIG. 5 is a flowchart of the method that the user terminal 10 obtains information related to other user terminal nodes that comprise the piece of the content corresponding to the candidate content identification information under the assistance from the second network server 40, according to an embodiment of the present invention.

FIG. 6 is a flow chart of the downloading method in user terminal 10 to download Flash video from network to the present user terminal, according to another embodiment of the invention.

FIG. 7 is a network schematic view that the user terminal 10 obtains multimedia content from multiple network recourses under the assistance from the first network server 30′, according to another embodiment of the invention.

FIG. 8 is a flow chart of the method for the user terminal 10 to obtain the address information of the same one or more file as the Flash video in the corresponding multimedia servers under the assistance from the first network server 30′, according to another embodiment of the invention.

FIG. 9 shows the block diagram of a downloading device for the user terminal 10 to download a Flash video from the network to the user terminal according to another embodiment of the invention.

FIG. 10 is a block diagram of the device for the user terminal 10 to obtain content identification information corresponding to the URL of the Flash video on the multimedia server 20 under the assistance from the first network server 30″, according to another embodiment of the present invention.

FIG. 11 is a block diagram of the device for the user terminal 10 to obtain information related to other user terminal nodes that comprise the piece of the content corresponding to the candidate content identification information under the assistance from the second network server 40, according to another embodiment of the present invention.

FIG. 12 is a block diagram of the download device for user terminal 10 to download Flash video from network to the present user terminal, according to another embodiment of the invention.

FIG. 13 is a block diagram of the download device for the user terminal 10 to obtain the address information of the same one or more file as the Flash video in the corresponding multimedia servers under the assistance from the first network server 30′, according to another embodiment of the invention.

### DETAILED DESCRIPTION OF THE EMBODIMENTS

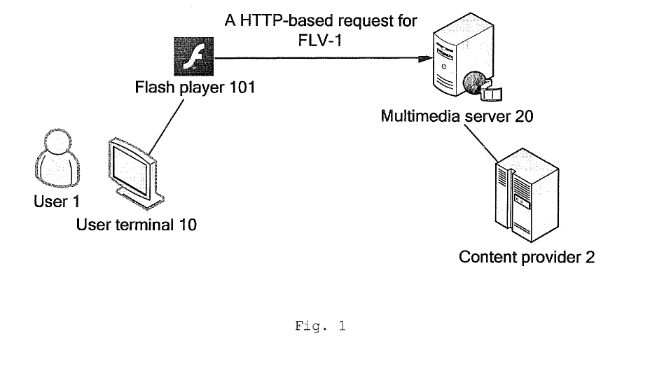

The following part will elucidate the embodiments of the invention from the point of systematic method with reference to FIG. 1 to FIG. 8.

### Embodiment 1

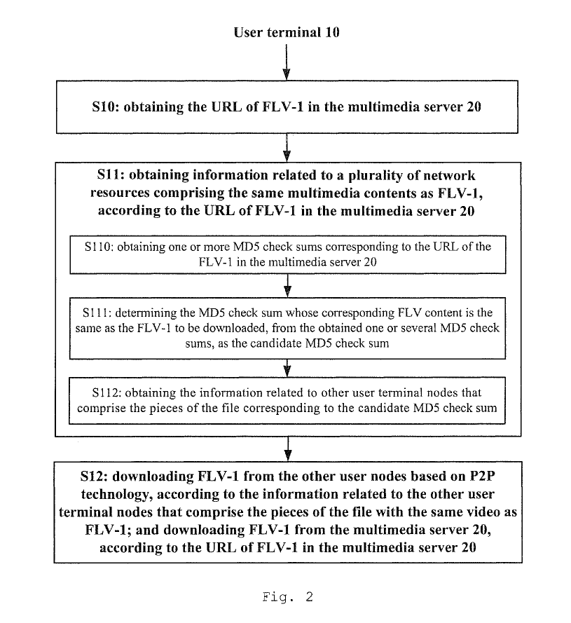

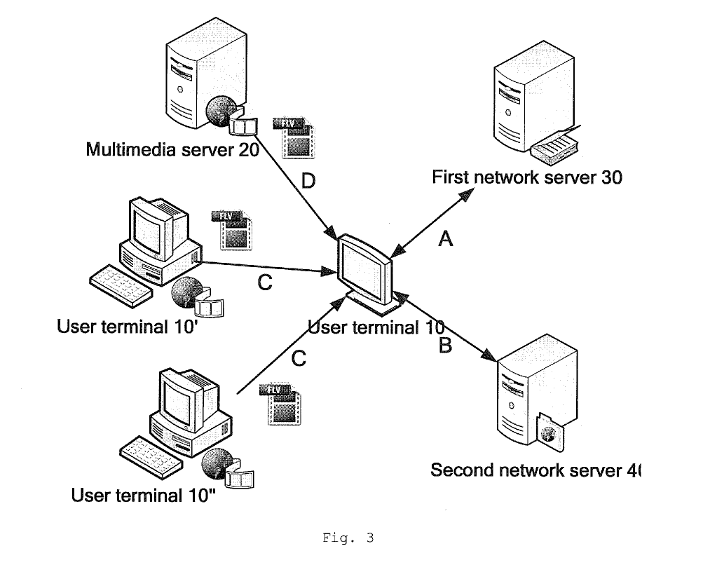

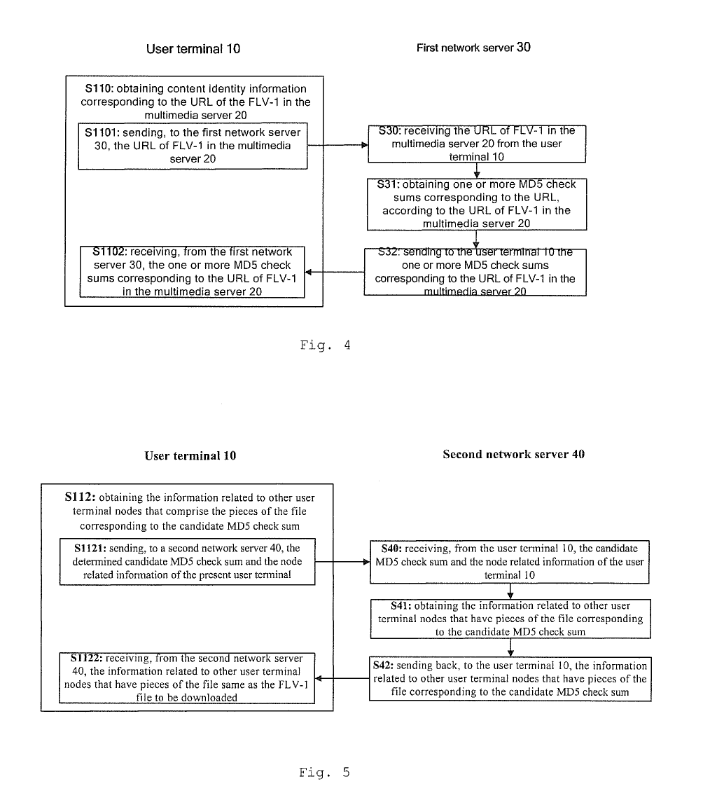

FIG. 1 is a schematic view of the network wherein a user terminal 10 requests to download a Flash video on a multimedia server 20, according to an embodiment of the invention. FIG. 2 shows the flowchart of downloading method that the user terminal 10 downloads a Flash video from the network to the user terminal according to an embodiment of the invention. FIG. 3 is a schematic view of the network wherein the user terminal 10 obtains the Flash video from a plurality of user terminal nodes under the assistance from a first network server 30 and a second network server 40, according to an embodiment of the present invention. FIG. 4 is a flowchart of the method that the user terminal 10 obtains content identification information corresponding to the URL of the Flash video on the multimedia server 20 under the assistance from the first network server 30, according to an embodiment of the present invention. FIG. 5 is a flowchart of the method that the user terminal 10 obtains information related to other user terminal nodes that comprise the piece of the content corresponding to the candidate content identification information under the assistance from the second network server 40, according to an embodiment of the present invention. The followings is an detailed description of the embodiment of the present invention with reference to FIG. 1 to FIG. 5.

As shown in FIG. 1, the user 1 attempts to download a Flash video in the embodiment. And one certain content provider on the Internet provides Internet users with this multimedia content in the form of a FLV file, and the file name is FLV-1. Generally, the file FLV-1 is located on a multimedia server 20 such as a HTTP server within the content provider 2. This multimedia server 20 could provide download service of random access type, namely the download service of stream for the user requesting for downloading FLV-1, by using partial download function of HTTP. The Internet browser on user terminal 10 of the user 1 is installed with a Flash player 101 for the content provider to which the FLV-1 belongs to. This Flash player 101 sends a for example HTTP-based download request for the FLV-1 in the way of for example active script, and this download request contains the URL information of the FLV-1 on the multimedia server 20. Meanwhile, the URL address of the FLV-1 on the multimedia server 20 of the content provider is hidden, which means that the URL address can not be extracted from the web page loaded in the Internet browser of the user terminal 10;

and the user terminal 10 could not obtain the status of the active script in the Flash player 101, either, namely the user terminal 10 couldn't obtain the URL information of the FLV-1 configured in the active script. Those skilled in the art could understand that this scenario is just for exemplifying, the invention is not limited by the example that the multimedia content is Flash video, the content provider provides an address-hidden file including the Flash video via HTTP server, and the user downloads the URL-hidden file of Flash video via a Flash player. The invention can also be used for scenarios that the content provider provides address-hidden multimedia content of other types, and user downloads the address-hidden multimedia content via other means.

Firstly, in step S10, the user terminal 10 obtains the URL of the FLV-1 on the multimedia server 20 during the procedure that the Flash player 101 obtains the FLV-1 on the multimedia server 20.

Specifically, in one embodiment, there are several Flash players running on the user terminal 10 simultaneously. And each Flash player requests for and plays a corresponding FLV file. The user terminal 10 could obtain all of these requests, but it couldn't determine which one among these requests is corresponding to the request for the FLV-1 from the Flash player 101. Since each Flash player generates an event corresponding to this Flash player when it sends the request for FLV file, one certain request can be determined as the request for FLV-1 from the Flasher player 101 in case that the certain request is found as the request corresponding to the event generated by the Flash player 101 among these requests.

The specific implementation is as follows: in step S100 (not shown in the figure), the user terminal 10 obtains the corresponding requests for one or more FLV files sent by the browser via the URL MON layer in the Internet browser installing the Flash player 101, and obtains the information related with the event generated by the Flasher player 101 for sending the request for FLV-1, when the Flash player 101 requests for the FLV-1 on the multimedia server 20. Wherein the mentioned corresponding requests for one or more FLV files include the request for FLV-1, and this request for FLV-1 contains the URL information of the FLV-1 on the multimedia server 20. Then, in step S102 (not shown in the figure), the user terminal 10 determines the request, associated with the obtained information related to the event, in the obtained one or more request, as an associated request. After that, in step S103 (not shown in the figure), the user terminal 10 obtains the URL information of the Flash file in the predetermined multimedia server 20 according to the associated request.

In another embodiment, at the same time the user terminal 10 only runs this Flash player 101, which requests for the file FLV-1 in the multimedia server 20. In this case the user terminal 10 obtains the only one request sent from Flash player on the URL MON layer of the Internet browser installing the Flash player 101, and it can obtain the URL of the Flash file in the multimedia server according to this request.

Those skilled in the art could understand that, the user terminal 10 could employ other ways to obtain the HTTP-based request for file FLV-1 sent from the Flash player 101, such as technology of data packet sniff, or catching and filtering the data packets sent by the network interface card. The practical ways for obtaining are numerous and all falls into the scope of the invention.

After obtaining the URL of FLV-1 in the multimedia server 20, in step S11, the user terminal 10 obtains information related to a plurality of network resources comprising the same Flash video as FLV-1, according to the URL of FLV-1 in the multimedia server 20. Wherein, in this embodiment, the plurality of network resources comprising the same Flash video as FLV-1 includes other user terminal nodes and/or the multimedia server 20.

In a preferred embodiment, the user terminal 10 obtains information related to other user terminals comprising the file with the same content as FLV-1, under the assistance from a first network server 30 and a second network server 40. As shown in FIG. 3, the user terminal 10 logically connects to the first network server 30 and the second network server 40 via the Internet, and the user terminal 10 can communicate with other user terminals comprising the file with the same content as FLV-1 via the Internet.

Specifically, in step S110, the user terminal 10 obtains content identification information corresponding to the URL of the FLV-1 in the multimedia server 20.

In one embodiment, the step S110 is shown in FIG. 4. In step S1101, the user terminal 10 sends, to the first network server 30, the URL of FLV-1 in the multimedia server 20 obtained in step S10.

Then, in step S30, the first network server 30 receives the URL of FLV-1 in the multimedia server 20 from the user terminal 10.

Then, in step S31, the first network server 30 obtains one or more content identification information corresponding to the URL, according to the URL of FLV-1 in the multimedia server 20. Specifically, the content identification information corresponds to the Flash video content of FLV-1, for example, it is the MD5 check sum of the file FLV-1. The MD5 check sum can be used for uniquely indicating the Flash video file, due to that the file with different content has different MD5 in a field large enough. Those skilled in the art could understand that this content identification information could be other information for uniquely indicating multimedia content, such as SHA-1. In a preferred embodiment, a user terminal, having downloaded FLV-1 according to the URL of FLV-1 in the multimedia server 20, feeds back the MD5 check sum of the FLV-1 file to the first network server 30. And the first network server 30 locally maintains the corresponding relationship between the MD5 check sum and the URL for example in a database. Then, in step S31, the first network server 30 inquires all the maintained corresponding relationships, and obtains the MD5 check sum corresponding to the URL of FLV-1 in the multimedia server 20. It should be noted that, however, since the content provider corresponding to the URL may modify or replace the FLV-1 corresponding to the URL, the MD5 check sum of the file FLV-1 currently corresponding to the URL may change. The first network server 30 can't change the maintained MD5 check sum corresponding to the URL in real time, thus the MD5 check sum corresponding to the URL may be just one or several; and this one or several MD5 check sums may include the MD5 check sum corresponding to the FLV-1 currently to be downloaded, or may include none corresponding to the FLV-1 currently to be downloaded.

Optionally, another network server maintains the corresponding relationship between the URL and MD5 check sum. Then the first network server 30 obtains the MD5 check sum corresponding to the URL of FLV-1 in the multimedia server 20 by inquiring the other network server.

Then, in step S32, the first network server 30 sends to the user terminal 10 the one or more MD5 check sums, obtained in step S31, corresponding to the URL of FLV-1 in the multimedia server 20.

After that, in step S1102, the user terminal 10 receives, from the first network server 30, the one or more MD5 check sums corresponding to the URL of FLV-1 in the multimedia server 20.

The above interaction procedure between the user terminal 10 and the first network server 30 is shown by the path A in FIG. 3.

In a varied embodiment, before the current download, the user terminal 10 has downloaded the file FLV-1 according to the URL of FLV-1 in the multimedia server 20 and obtained the MD5 check sum of the file FLV-1, and it also maintained the corresponding relationship between the URL at that time and the MD5 check sum of the file FLV-1 such as by means of mapping table. Then, in step S110, the user terminal 10 could inquiry the locally maintained corresponding relationship between the URL and MD5 check sum, and obtains the MD5 check sum corresponding to the URL of FLV-1 in the multimedia server 20. It should be noted that, however, since the content provider corresponding to the URL may modify or replace the FLV-1 corresponding to the URL, the MD5 check sum of the file FLV-1 corresponding to the URL may change, and the MD5 check sum locally stored by the user terminal 10 doesn't correspond to the current FLV-1.

Those skilled in the art understand that, the method in step S110 for the user terminal 10 to obtain the MD5 check sum corresponding to the URL of FLV-1 in the multimedia server 20 is not limited by the above two examples.

Then, in step S111, the user terminal 10 determines the MD5 check sum whose corresponding FLV content is the same as the FLV-1 to be downloaded by the user terminal 10, from the one or several MD5 check sums obtained in step S110, as the candidate MD5 check sum. Due to the above mention reason that the content provider may change the file FLV-1 corresponding to the URL, the FLV file downloaded according to the MD5 check sum may be different from the currently requested FLV-1 if the user terminal 10 doesn't validate the MD5 check sum obtained in step S110. In an embodiment, the user terminal 10 could send the one or several MD5 check sum to the multimedia server 20, and the multimedia server 20 informs the user terminal 10 of the right MD5 check sum. Those skilled in art should understand that the methods for the user terminal to validate the MD5 check sum are various and are not limited by the embodiment.

After that, in step S112, the user terminal 10 obtains the information related to other user terminal nodes that comprise the pieces of the file corresponding to the candidate MD5 check sum.

In one embodiment, the step S112 is shown in FIG. 5. In step S1121, the user terminal 10 sends, to the second network server 40, the candidate MD5 check sum determined in step S111 and the node related information of the present user terminal.

Then, in step S40, the second network server 40 receives, from the user terminal 10, the candidate MD5 check sum and the node related information of the user terminal 10.

Then, in step S41, the second network server 40 obtains the information related to other user terminal nodes that have pieces of the file corresponding to the candidate MD5 check sum, according to the candidate MD5 check sum. Specifically, the second network server 40 maintains, in the way of mapping table or database, the information such as IP address of all other user terminal nodes that is downloading or had downloaded the pieces of the file corresponding to the candidate MD5 check sum. And the second network server 40 obtains the IP address information of other terminals 10′ and 10″ that have pieces of the file corresponding to the candidate MD5 check sum.

Then, in step S42, the second network server 40 sends back, to the user terminal 10, the IP address information of the other terminals 10′ and 10″ that have pieces of the file corresponding to the candidate MD5 check sum.

In step S1122, the user terminal 10 receives, from the second network server 40, the related information of other terminal 10′ and 10″ that have pieces of the file same as the file FLV-1 to be downloaded.

The above interaction procedure between the user terminal 10 and the second network server 40 is shown by the path B in FIG. 3.

In another embodiment, the user terminal 10 and other user terminal nodes that have pieces of the file corresponding to the candidate MD5 check sum are located in the same Distributed Hash Table (DHT) network. Each of the user terminals takes charge of routing in a small scope, and of storing a small amount of data so as to implement the addressing and routing in the whole DHT network. In this case, in step S112, the user terminal 10 could search for other user terminals to download the file corresponding to the candidate MD5 check sum, without depending on the second network server 40, and obtain the information related to these user terminal nodes. The specific method for obtaining the information of other terminals based on DHT technology is not the focus of the invention, and those skilled in the art could achieve this function according to the art.

Those skilled in the art understand that, the method in step S112, for the user terminal 10 to obtain the information related to other user terminal nodes that comprise the pieces of the file corresponding to the candidate MD5 check sum, is not limited by the above two examples.

In another embodiment, the user terminal 10 determines whether the one or more MD5 check sum obtained in step S110 correspond to the content of the FLV-1 currently requested to be downloaded in a pre-download manner: the user terminal 10 firstly sends directly all the obtained MD5 checksum to the second network server 40, the second network server 40 sends back to the user terminal 10 the IP address information of each the user terminal comprising the piece of contents corresponding to each MD5; then, the user terminal 10 downloads a part, say the previous 10K data, of the multimedia content from the multimedia server 20 respectively, and downloads the corresponding part, say the previous 10K, of the file corresponding to each MD5, from each user terminal. The user terminal 10 then compares the part downloaded from the multimedia server 20 with the corresponding part of the file corresponding to each MD5: the MD5 of the file whose downloaded part is the same as the part downloaded from the multimedia server 20 is the valid check sum. The user terminal 10 can determine that the user terminals 10′ and 10″, corresponding to the valid MD5 check sum, store the piece of Flash video same as the FLV-1 to be downloaded

After that, in step S12, the user terminal 10 downloads FLV-1 from the user terminals 10′ and 10″ simultaneously based on P2P technology, according to the information related to the plurality of other user terminal nodes that comprise the pieces of the file with the same Flash video as FLV-1, obtained in step S11, as shown by the path C in FIG. 3. The detailed technical solution of downloading based on P2P technology is not a focus of the invention, and those skilled in the art could implement this function according to the prior art . Meanwhile, the user terminal 10 may also download from the multimedia server 20, the part of FLV-1 that isn't downloaded based on P2P technology from the user terminal 10′ and 10″, according to the URL of FLV-1 in the multimedia server 20 obtained in step S10, as shown in path D in FIG. 3. In this manner, the downloading of FLV-1 simultaneously from multiple network resources greatly increases the speed of downloading FLV-1. Finally, the user terminal 10 combines the data downloaded from the multimedia server 20 with the data downloaded based on P2P technology as the complete file FLV-1.

In a preferred embodiment, in step S13, in the process of downloading the file FLV-1, the user terminal 10 reports, to the first network server 30, the status information of the currently downloaded FLV-1. Wherein, the status information preferably comprises the MD5 check sum of the FLV-1 downloaded by the user terminal 10.

After that, in step S33, the first network server 30 obtains the status information of the currently downloaded FLV-1 reported by the user terminal 10 in the process of downloading the file FLV-1. Wherein, the status information preferably comprises the MD5 check sum of the FLV-1 downloaded by the user terminal 10.

Then, in step S34, the first network server 30 creates or updates the MD5 check sum corresponding to the URL address of the FLV-1 in the multimedia server 20, according to the MD5 check sum of the downloaded file FLV-1 reported by the user terminal 20. Specifically, in case that the user terminal 10 is the first user that downloads this file from this URL address, the user terminal 10 provides the first network server 30 with this URL together with the MD5 check sum of the file FLV-1, and the first network server 30 creates the corresponding relationship between the MD5 check sum and the URL of file FLV-1 in multimedia server 20 by using technologies for example the database; and in case as mentioned above that the content provider corresponding to the URL modifies the file FLV-1 corresponding to the URL and causes that the MD5 check sum of the file FLV-1 corresponding to the URL changes, the user terminal 10 downloads the modified FLV-1 according to the URL and provides the first network server 30 with the new MD5 check sum of the new file FLV-1, then the first network server 30 updates the MD5 check sum corresponding to the URL address of the file FLV-1 in the multimedia server 20 as the MD5 check sum of the new file FLV-1.

The above part describes the technical solution that the user terminal 10 obtains the URL of FLV-1 in multimedia server 20, obtains the MD5 check sum corresponding to the URL, then acquires the other user terminals that comprises the pieces of the file corresponding to the MD5 check sum, and downloads the FLV-1 from the other user terminals based on P2P technology. The following part will describe a technical solution for downloading Flash video according to another aspect of the invention.

### Embodiment 2

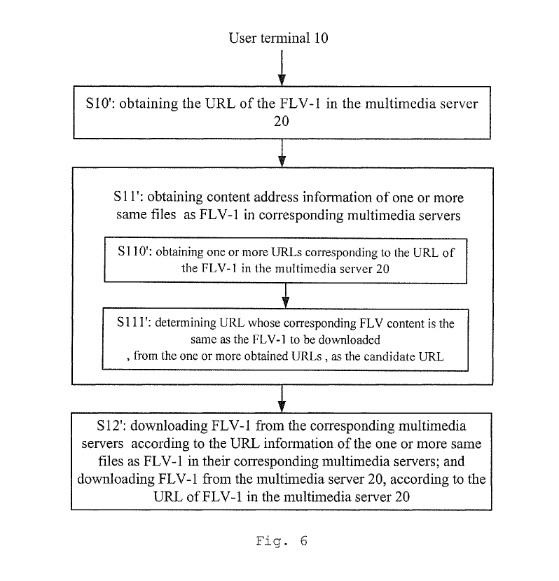

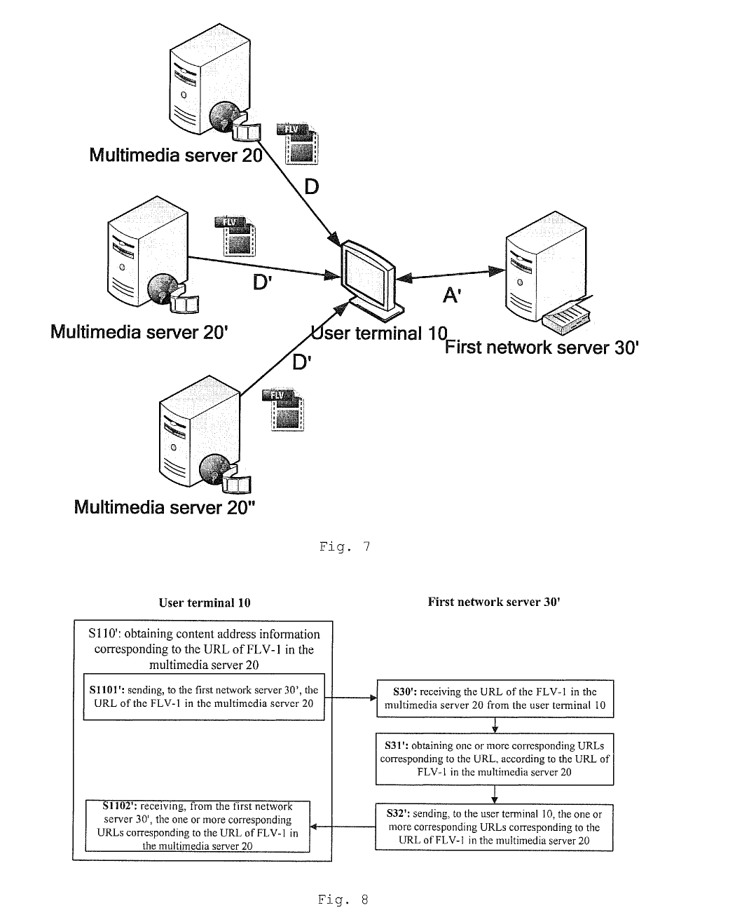

FIG. 6 is a flow chart of the downloading method in user terminal 10 to download Flash video from network to the present user terminal, according to another embodiment of the invention. FIG. 7 is a network schematic view that the user terminal 10 obtains multimedia content from multiple network recourses under the assistance from the first network server 30′, according to another embodiment of the invention. FIG. 8 is a flow chart of the method for the user terminal 10 to obtain the address information of the one or more file same as the Flash video in the corresponding multimedia servers under the assistance from the first network server 30′, according to another embodiment of the invention.

Similar to the abovementioned embodiment 1, as shown in FIG. 1, the user 1 uses the user terminal 10 to download a Flash video. And an HTTP-based multimedia server 20 of a content provider 2 on the Internet provides Internet users with this Flash video in the form of a FLV file, and the file name is FLV-1. The Internet browser on user terminal 10 of the user 1 is installed with a Flash player 101 for the content provider to which the FLV-1 belongs to. This Flash player 101 sends for example an HTTP-based download request for the FLV-1 in the way of for example active script, and this download request contains the /URL information of the FLV-1 on the multimedia server 20. However, the URL address of the FLV-1 on the multimedia server 20 of the content provider is hidden. Those skilled in the art could understand that the invention is not limited by this scenario and can also be used for scenarios that the content provider provides address-hidden multimedia content of other types, and the user downloads the address-hidden multimedia content via other means.

As shown in FIG. 6, firstly, in step S10′, the user terminal 10 obtains the URL of the FLV-1 in the multimedia server 20 during the procedure that the Flash player 101 obtains the FLV-1 in the multimedia server 20. The specific method for obtaining is similar as that instep S10 in embodiment 1, thus will not be described unnecessarily.

After obtaining the URL of the FLV-1 in the multimedia server 20, in step S11′, the user terminal 10 obtains information related to multiple network resources comprising the same Flash video as FLV-1, according to the URL of the FLV-1 in the multimedia server 20. Wherein, in the present embodiment, the multiple network resources comprising the same Flash video as FLV-1 includes other multimedia servers and/or the multimedia server 20.

In a preferred embodiment, the user terminal 10 obtains information related to multiple other multimedia servers comprising files with the same video content as FLV-1, under the assistance from the first network server 30′. As shown in FIG. 7, the user terminal 10 logically connects to the first network server 30′ via the Internet, and the user terminal 10 can communicate with the multiple other multimedia servers comprising files with the same video contents as FLV-1 via the Internet.

Wherein, in step S110′ the user terminal 10 obtains the content address information corresponding to the URL of the FLV-1 in the multimedia server 20.

In one embodiment, the step S110′ is shown in FIG. 8. In step S1101′, the user terminal 10 sends, to the first network server 30′, the URL of the FLV-1 in the multimedia server 20 obtained in step S10′.

Then, in step S30′ the first network server 30′ receives the URL of the FLV-1 in the multimedia server 20 from the user terminal 10.

Then, in step S31′, the first network server 30′ obtains one or more content address information related to the URL, according to the URL of FLV-1 in the multimedia server 20. The content address information is for example the URLs of some certain files in the corresponding servers. In a preferred embodiment, a user terminal, have downloaded FLV-1 according to the URL of FLV-1 in the multimedia server 20, and fed back the MD5 check sum of the FLV-1 file together with the URL to the first network server 30′; and other one or more user terminals have also downloaded this file according to the URLs of one or more Flash video files with the same content in the corresponding servers, and reports to the first network server 30′ the corresponding URLs together with a unique identification information such as MD5 check sum of the file with the same content. And the first network server 30′ locally maintains the corresponding relationship between the URL of FLV-1 in multimedia server 20 and the URLs of one or more Flash video files with the same content in the corresponding servers, according to the same unique identification information, for example in a database. Then, in step S31′, the first network server 30′ inquires all the maintained corresponding relationships, and obtains the one or more URLs corresponding to the URL of FLV-1 in the multimedia server 20. It should be noted that, however, since the content provider corresponding to the URL may modify or replace the file corresponding to the URL, which may cause that the URL may not correspond to the file FLV-1 in fact. However, the first network server 30′ can't update in real time the maintained corresponding relationship between this URL and the corresponding URLs automatically. Thus the one or more URLs obtained by the first network server 30′ may include one or more URLs corresponding to the FLV-1 currently to be downloaded, or may include none corresponding to the FLV-1 currently to be downloaded.

In another embodiment, another network server maintains the corresponding relationship between the URL and the one or more corresponding URLs. Then the first network server 30′ obtains the one or more corresponding URLs corresponding to the URL of FLV-1 in the multimedia server 20 by inquiring the another network server.

Then, in step S32′, the first network server 30′ sends, to the user terminal 10, the one or more corresponding URLs corresponding to the URL of FLV-1 in the multimedia server 20 obtained in step S31′.

After that, in step S1102′, the user terminal 10 receives the one or more corresponding URLs corresponding to the URL of FLV-1 in the multimedia server 20.

The above procedure of interaction between the user terminal 10 and the first network server 30′ is shown by the path A′ in FIG. 7.

In a varied embodiment, before the current download, the user terminal 10 has downloaded the file FLV-1 according to the URL of FLV-1 in the multimedia server 20 and the URLs of one or more Flash video file with the same content in the corresponding servers. Then, in step S110′, the user terminal 10 could inquire the locally maintained corresponding relationship between the URL of FLV-1 in multimedia sever 20 and other corresponding URLs, and obtain one or more URLs corresponding to the URL of FLV-1 in multimedia sever 20. However, it should be appreciated that since the content provider corresponding to the URL may modify the file corresponding to the URL, and the URL may not correspond to FLV-1 in fact. However, the user terminal 10 can't automatically update in real time the maintained corresponding relationship between this URL and the corresponding URLs. Thus the one or more corresponding URLs obtained by the user terminal 10 may include one or more URLs corresponding to the FLV-1 currently to be downloaded, or may include none corresponding to the FLV-1 currently to be downloaded.

Then, in step S111′, the user terminal 10 determines one or more URLs whose content of the corresponding file is the same as the FLV-1 to be downloaded, from the one or more corresponding URLs obtained in step S110′, as the candidate

URLs. Due to the above mention reason that the content provider may change the file FLV-1 corresponding to the URL, the FLV file downloaded according to the URL may be different from the currently requested file FLV-1 if the user terminal 10 doesn't validate the URL obtained in step S110′. In the embodiment, the user terminal 10 determines that multimedia server 20′ and 20″ comprise files with the same content as FLV-1, and thus determines the corresponding URLs as the candidate URLs. In one embodiment, the user terminal 10 could download a certain amount of data in the same location in the corresponding files according to the one or more URLs and the URL of FLV-1 in the multimedia server 20, and determines whether the downloaded data are identical, so as to determine whether files corresponding to the one or more URLs corresponds to FLV-1, in order to validate the one or more URLs. Those skilled in art should understand that the methods for the user terminal to validate the one or more URL are various and is not limited by the embodiment.

After that, in step S12′, the user terminal 10 downloads FLV-1 simultaneously from the multimedia servers 20′ and 20″, according to the candidate URLs of the multimedia servers 20′ and 20″ comprising the same Flash video as FLV-1, obtained in step S11′, as shown by the path D′ in FIG. 7. Meanwhile, the user terminal 10 may also download from the multimedia server 20, the part of FLV-1 that isn't downloaded from the multimedia server 20′ and 20″, according to the URL of FLV-1 in the multimedia server 20 obtained in step S10′, as shown in path D in FIG. 7. In this manner, the downloading of FLV-1 simultaneously from multiple network resources greatly increases the speed of downloading FLV-1. Finally, the user terminal 10 combines the data downloaded from the multimedia server 20 with the data downloaded from the multimedia servers 20′ and 20″ as the complete file FLV-1.

In a preferred embodiment, in step S13′, in the process of downloading the file FLV-1, the user terminal 10 reports, to the first network server 30′, the status information of the currently downloaded FLV-1. Wherein, the status information preferably comprises the status of downloading according to the one or more URLs corresponding to the URL of FLV-1 in the multimedia server 20 and/or the URL of FLV-1 in the multimedia server 20, and/or the MD5 check sum of the FLV-1.

After that, in step S33′, the first network server 30′ obtains the status information of the currently downloaded FLV-1 reported by the user terminal 10 in the process of downloading the file FLV-1. Wherein, the status information preferably comprises the status of downloading according to the one or more URLs corresponding to the URL of FLV-1 in the multimedia server 20 and/or the URL of FLV-1 in the multimedia server 20, and/or the MD5 check sum of the FLV-1.

Then, in step S34′, the first network server 30′ creates or updates the URLs corresponding to the URL of the FLV-1 in the multimedia server 20, according to the status of downloading according to the candidate URL and/or the URL of the FLV-1 in the multimedia server 20, reported by the user terminal 10. Specifically, in case that the user terminal 10 is the first user that downloads this file from one certain URL, the user terminal 10 downloads the FLV-1 according to the URL of FLV-1 in the multimedia server 20, and provides the first network server 30′ with this URL together with the MD5 check sum of the file FLV-1, and the first network server 30′ co-relates all URLs with the same MD5 check sums; and in case that the content provider corresponding to the URL modifies the file FLV-1 corresponding to the URL as previously mentioned and causes that the file FLV-1 corresponding to this URL is false, and the user terminal 10 couldn't download the FLV-1 according to this URL, the user terminal 10 notifies the first network server 30′ of this false status, then the first network server 30′ deletes the relationship between this false URL and other URLs.

The above part elucidates the embodiments of the invention from the point of systematic method.

### Embodiment 3

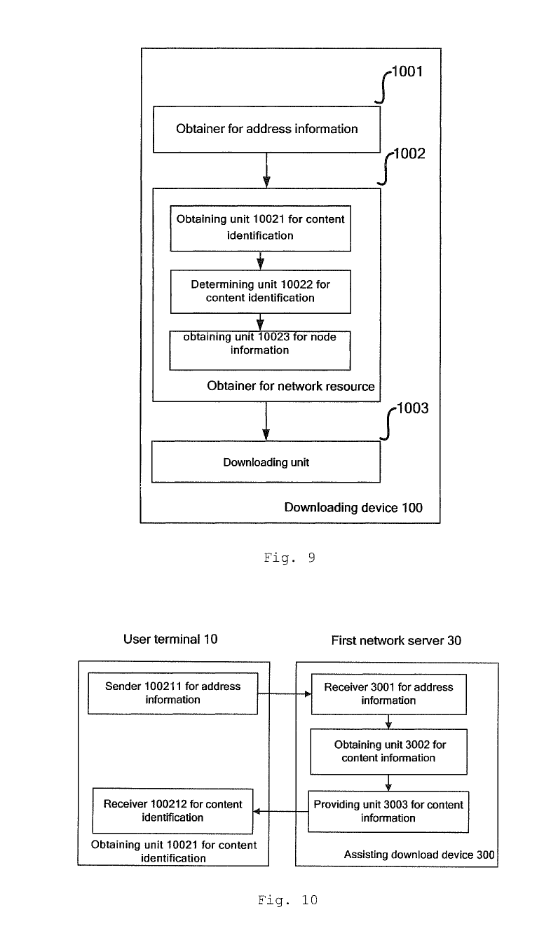

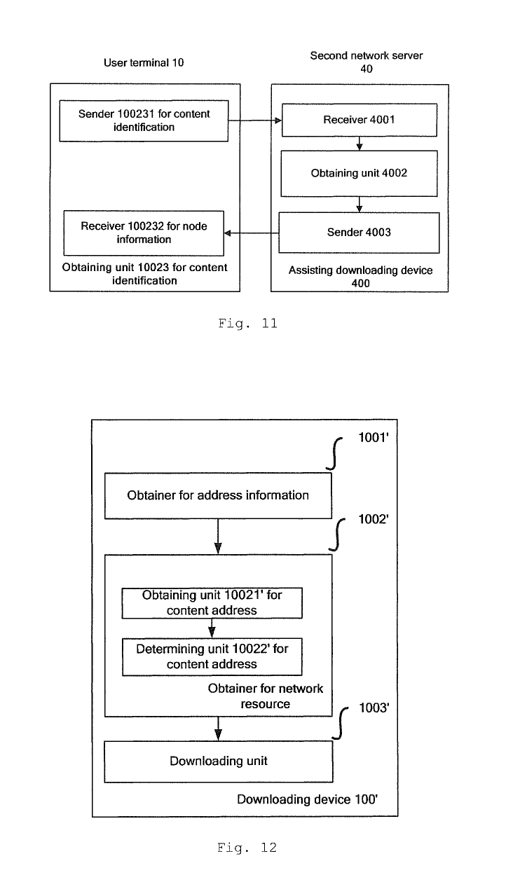

FIG. 9 shows the block diagram of a downloading device for the user terminal 10 to download a Flash video from the network to the user terminal according to another embodiment of the invention. FIG. 10 is a block diagram of the device for the user terminal 10 to obtain content identification information corresponding to the URL of the Flash video on the multimedia server 20 under the assistance from the first network server 30, according to another embodiment of the present invention. FIG. 11 is a block diagram of the device for the user terminal 10 to obtain information related to other user terminal nodes that comprise the piece of the content corresponding to the candidate content identification information under the assistance from the second network server 40, according to another embodiment of the present invention. The followings are a detailed description of the embodiment of the present invention with reference to FIG. 1, FIG. 3 and FIG. 9 to FIG. 11.

As shown in FIG. 1, the user 1 attempts to download a Flash video by using user terminal 10. And an HTTP server 20 of one certain content provider 2 on the Internet provides Internet users with this FLV video in the form of a FLV file, and the file name is FLV-1. The Internet browser on user terminal 10 of the user 1 is installed with a Flash player 101 for the content provider to which the FLV-1 belongs to. This Flash player 101 sends a for example HTTP-based download request for the FLV-1 in the way of for example active script, and this download request contains the URL information of the FLV-1 on the multimedia server 20. However, the URL address of the FLV-1 on the multimedia server 20 of the content provider is hidden. Those skilled in the art could understand that the invention is not limited by the scenario, and the invention can also be used for scenarios that the content provider provides address-hidden multimedia content of other types, and user downloads the address-hidden multimedia content via other means.

In the present embodiment, as shown in FIG. 9, the user terminal 10 comprises a downloading device 100 for downloading multimedia contents to be downloaded from the network to the local user terminal, wherein, the downloading device 100 comprises an obtainer 1001 for address information, an obtainer 1002 for network resource, and a downloading unit 1003. The obtainer 1002 for network resource further comprises an obtaining unit 10021 for content identification, a determining unit 10022 for content identification, and an obtaining unit 10023 for node information.

Firstly, the obtainer 1001 for address information obtains the URL of the FLV-1 on the multimedia server 20 during the procedure that the Flash player 101 obtains the FLV-1 on the multimedia server 20.

Specifically, in one embodiment, there are several Flash players running on the user terminal 10 simultaneously. And each Flash player requests for and plays a corresponding FLV file. The user terminal 10 could obtain all of these requests, but it couldn't determine which one among these requests is corresponding to the request for the FLV-1 from the Flash player 101. Since each Flash player generates an event corresponding to this Flash player when it sends the request for FLV file, one certain request can be determined as the request for FLV-1 from the Flasher player 101 in case that the certain request is found as the request corresponding to the event generated by the Flash player 101 among these requests.

In the present embodiment, the obtainer 1001 for address information further comprises a first obtaining unit 10011, a first determining unit 10012 and a second obtaining unit 10013 (all of which are not shown in the figure). The first obtaining unit 10011 obtains the corresponding requests for one or more FLV files sent by the browser via the URL MON layer in the Internet browser installing the Flash player 101, and obtains the information related with the event generated by the Flasher player 101 for sending the request for FLV-1, when the Flash player 101 requests for the FLV-1 on the multimedia server 20. Wherein the mentioned corresponding requests for one or more FLV files include the request for FLV-1, and this request for FLV-1 contains the URL information of the FLV-1 on the multimedia server 20. Then, the first determining unit 10012 determines the request, associated with the obtained information related to the event, in the obtained one or more request, as an associated request.

After that, the second obtaining unit 10013 obtains the URL information of the Flash file in the predeterminedmultimedia server according to the associated request.

In another embodiment, at the same time the user terminal 10 only runs this Flash player 101, which requests for the file FLV-1 in the multimedia server 20. In this case the obtainer 1001 for address information obtains the only one request sent from Flash player on the URL MON layer of the Internet browser installing the Flash player 101, and it can obtain the URL of the Flash file in the multimedia server 20 according to this request.

Those skilled in the art could understand that, the obtainer 1001 for address information could employ other ways to obtain the HTTP-based request for file FLV-1 sent from the Flash player 101, such as technology of data packet sniff, or catching and filtering the data packets sent by the network interface card. The practical ways for obtaining are numerous and all falls into the scope of the invention.

After the URL of FLV-1 in the multimedia server 20 is obtained, the obtainer 1002 for network resource obtains information related to a plurality of network resources comprising the same Flash video as FLV-1, according to the URL of FLV-1 in the multimedia server 20. Wherein, in this embodiment, the plurality of network resources comprising the same Flash video as FLV-1 includes other user terminal nodes and/or the multimedia server 20.

In a preferred embodiment, the user terminal 10 obtains information related to other user terminals comprising the file with the same video content as FLV-1, under the assistance from a first network server 30 and a second network server 40. As shown in FIG. 3, the user terminal 10 logically connects to the first network server 30 and the second network server 40 via the Internet, and the user terminal 10 can communicate with other user terminals comprising the file with the same video content as FLV-1 via the Internet.

In one embodiment, as shown in FIG. 10, the obtaining unit 10021 for content identification obtains at least one content identification information corresponding to the URL of the FLV-1 in the multimedia server 20, under the assistance of the first network server 30. The obtaining unit 10021 for content identification further comprises a sender 100211 for address information and a receiver 100212 for content identification. The assisting download device 300, in the first network server 30, for assisting the user terminal to download the multimedia contents from the network to the user terminal with high speed comprises a receiver 3001 for address information, an obtaining unit 3002 for content information and a providing unit 3003 for content information.

Firstly, the sender 100211 for address information sends, to the first network server 30, the URL of FLV-1 in the multimedia server 20 obtained by the obtainer 1001 for address information.

Then, a receiver 3001 for address information of the assisting download device 300 of first network server 30 receives the URL of FLV-1 in the multimedia server 20 from the user terminal 10.

After that, the obtaining unit 3002 for content information obtains one or more content identification information corresponding to the URL, according to the URL of FLV-1 in the multimedia server 20. Specifically, the content identification information corresponds to the Flash video content of FLV-1, for example, it is the MD5 check sum of the file FLV-1. The MD5 check sum can be used for uniquely indicating the Flash video file, due to that the file with different content has different MD5. In a preferred embodiment, a user terminal, having downloaded FLV-1 according to the URL of FLV-1 in the multimedia server 20, feeds back the MD5 check sum and URL of the FLV-1 file to the first network server 30. And the first network server 30 locally maintains the corresponding relationship between the MD5 check sum and the URL for example in a database. Then, the obtaining unit 3002 for content information inquires all the maintained corresponding relationships, and obtains the MD5 check sum corresponding to the URL of FLV-1 in the multimedia server 20. It should be noted that, however, since the content provider corresponding to the URL may modify or replace the FLV-1 corresponding to the URL, the MD5 check sum of the file FLV-1 corresponding to the URL may change. The first network server 30 can't change the maintained MD5 check sum corresponding to the URL in real time, thus the MD5 check sum corresponding to the URL may be just one or several; and this one or several MD5 check sums may include the MD5 check sum corresponding to the FLV-1 currently to be downloaded, or may include none corresponding to the FLV-1 currently to be downloaded.

Optionally, another network server maintains the corresponding relationship between the URL and MD5 check sum. Then the obtaining unit 3002 for content information obtains the MD5 check sum corresponding to the URL of FLV-1 in the multimedia server 20 by inquiring the other network server.

Then, the providing unit 3003 for content information sends to the user terminal 10 the one or more MD5 check sums, corresponding to the URL of FLV-1 in the multimedia server 20, obtained by the obtaining unit 3002 for content information.

After that, the receiver 100212 for content identification of the downloading device 100 of user terminal 10 receives, from the first network server 30, the one or more MD5 checksums corresponding to the URL of FLV-1 in the multimedia server 20.

The above interaction procedure between the user terminal 10 and the first network server 30 is shown by the path A in FIG. 3.

In a varied embodiment, before the current download, the user terminal 10 has downloaded the file FLV-1 according to the URL of FLV-1 in the multimedia server 20 and obtained the MD5 check sum of the file FLV-1, and it also maintained the corresponding relationship between the URL at that time and the MD5 check sum of the file FLV-1 such as by means of mapping table. Then, the obtaining unit 10021 for content identification could inquiry the locally maintained corresponding relationship between the URL and MD5 check sum, and obtains the MD5 check sum corresponding to the URL of FLV-1 in the multimedia server 20. It should be noted that, however, since the content provider corresponding to the URL may modify or replace the FLV-1 corresponding to the URL, the MD5 check sum of the file FLV-1 corresponding to the URL may change, and the MD5 check sum locally stored by the user terminal 10 doesn't correspond to the current FLV-1.

Those skilled in the art understand that, the method used by the obtaining unit 10021 for content identification to obtain the MD5 check sum corresponding to the URL of FLV-1 in the multimedia server 20 is not limited by the above two examples.

Then, the determining unit 10022 for content identification determines the MD5 check sum whose corresponding FLV content is the same as the FLV-1 to be downloaded by the user terminal 10, from the one or several MD5 check sums obtained by the obtaining unit 10021 for content identification, as the candidate MD5 check sum. Due to the above mention reason that the content provider may change the file FLV-1 corresponding to the URL, the FLV file downloaded according to the MD5 check sum may be different from the currently requested FLV-1 if the user terminal 10 doesn't validate the MD5 check sum obtained by the obtaining unit 10021 for content identification.

After that, the obtaining unit 10023 for node information obtains the information related to other user terminal nodes that comprise the pieces of the file corresponding to the candidate MD5 check sum.

In one embodiment, as shown in FIG. 11, the obtaining unit 10023 for node information obtains the information related to nodes under the assistance of a second network server 40. Wherein, the obtaining unit 10023 for node information comprises a sender 100231 for content identification and a receiver 100232 for node information. The assisting downloading device 400, in the second network server 40, for assisting a user terminal to download multimedia contents to be downloaded from the network with high speed comprises a receiver 4001, an obtaining unit 4002 and a sender 4003.

Specifically, the sender 100231 for content identification sends, to the second network server 40, the candidate MD5 check sum determined by the determining unit 10022 for content identification and the node related information of the present user terminal.

Then, the receiver 4001 of the assisting downloading device 400 in the second network server 40 receives, from the user terminal 10, the candidate MD5 check sum and the node related information of the user terminal 10. Wherein the file corresponding to the candidate MD5 check sum has the same file content as that of the file FLV-1 to be downloaded.

Then, the obtaining unit 4002 obtains the information related to other user terminal nodes that have pieces of the file corresponding to the candidate MD5 check sum, according to the candidate MD5 check sum. Specifically, the second network server 40 maintains, in the way of mapping table or database, the information such as IP address of all other user terminal nodes that is downloading or had downloaded the pieces of the file corresponding to the candidate MD5 check sum. And the second network server 40 obtains the IP address information of other terminals 10′ and 10″ that have pieces of the file corresponding to the candidate MD5 check sum.

Then, the sender 4003 sends back, to the user terminal 10, the IP address information of the other terminal 10′ and 10″ that have pieces of the file corresponding to the candidate MD5 check sum.

The receiver 100232 for node information of the user terminal 10 receives, from the second network server 40, the related information of other terminals 10′ and 10″ that have pieces of the file same as the file FIV-1 to be downloaded.

The above interaction procedure between the user terminal 10 and the second network server 40 is shown by the path B in FIG. 3.

In another embodiment, the user terminal 10 and other user terminal nodes that have pieces of the file corresponding to the candidate MD5 check sum are located in the same Distributed Hash Table (DHT) network. Each of the user terminals takes charge of routing in a small scope, and of storing a small amount of data so as to implement the addressing and routing in the whole DHT network. In this case, the obtaining unit 10023 for node information could search for other user terminals to download the file corresponding to the candidate MD5 check sum, without depending on the second network server, and obtain the information related to these user terminal nodes. The specific method for obtaining the information of other terminals based on DHT technology is not the focus of the invention, and those skilled in the art could achieve this function according to the art.

Those skilled in the art understand that, the method used by the obtaining unit 10023 for node information to obtain the information related to other user terminal nodes that comprise the pieces of the file corresponding to the candidate MD5 check sum, is not limited by the above two examples.

After that, the downloading unit 1003 downloads FLV-1 from the user terminals 10′ and 10″ simultaneously based on P2P technology, according to the information related to the plurality of other user terminal nodes that comprise the pieces of the file with the same Flash video as FLV-1, obtained by the obtainer 1002 for network resource, as shown by the path C in FIG. 3. The detailed technical solution of downloading based on P2P technology is not a focus of the invention, and those skilled in the art could implement this function according to the prior art. Meanwhile, the downloading unit 1003 may also download from the multimedia server 20, the part of FLV-1 that isn't downloaded based on P2P technology from the user terminal 10′ and 10′, according to the URL of FLV-1 in the multimedia server 20 obtained by the obtainer 1001 for address information, as shown in path D in FIG. 3. In this manner, the downloading of FLV-1 simultaneously from multiple network resources greatly increases the speed of downloading FLV-1. Finally, the downloading unit 1003 combines the data downloaded from the multimedia server 20 with the data downloaded based on P2P technology as the complete file FLV-1.

In a preferred embodiment, the downloading device 100 of user terminal 10 further comprises a first reporting unit 1004. And the assisting download device 300 of the first network server 30 further comprises a first receiver 3004 for report and a managing unit 3005 for content identification.

In the process of downloading the file FLV-1, the first reporting unit 1004 reports, to the first network server 30, the status information of the currently downloaded FLV-1. Wherein, the status information preferably comprises the MD5 check sum of the FLV-1 downloaded by the user terminal 10.

After that, the first receiver 3004 for report of the first network server 30 obtains the status information of the currently downloaded FLV-1 reported by the user terminal 10 in the process of downloading the file FLV-1. Wherein, the status information preferably comprises the MD5 check sum of the FLV-1 downloaded by the user terminal 10.

Then, the managing unit 3005 for content identification creates or updates the MD5 check sum corresponding to the URL address of the FLV-1 in the multimedia server 20, according to the MD5 check sum of the downloaded file FLV-1 reported by the user terminal 20. Specifically, in case that the user terminal 10 is the first user that downloads this file, the user terminal 10 downloads the FLV-1 according to the URL of the FLV-1 in the multimedia server 20 and provides the MD5 checksum of the FLV-1 file to the first network server 30. Then, the managing unit 3005 for content identification creates the corresponding relationship between the MD5 check sum and the URL of file FLV-1 by using technologies for example the database; and in case as mentioned above that the content provider corresponding to the URL modifies the file FLV-1 corresponding to the URL and causes that the MD5 check sum of the file FLV-1 corresponding to the URL changes, the user terminal 10 downloads the modified FLV-1 according to the URL and provides the first network server 30 with the new MD5 check sum of the new file FLV-1, then the managing unit 3005 for content identification updates the MD5 check sum corresponding to the URL address of the file FLV-1 in the multimedia server 20 as the MD5 check sum of the new file FLV-1.

The above part describes the technical solution that the downloading device 100 of user terminal 10 obtains the URL of FLV-1 in multimedia server 20, obtains the MD5 check sum corresponding to the URL, then acquires the other user terminals that comprises the pieces of the file corresponding to the MD5 check sum, and downloads the FLV-1 from the other user terminals based on P2P technology. The following part will describe a technical solution for downloading Flash video according to another aspect of the invention.

### Embodiment 4

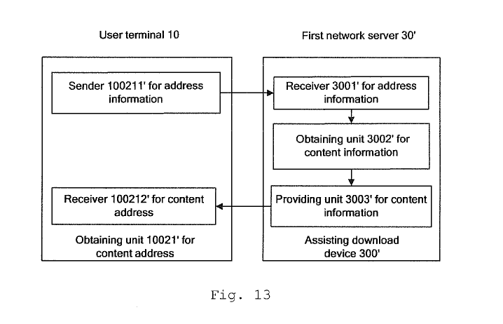

FIG. 12 is a block diagram of the download device for user terminal 10 to download Flash video from network to the present user terminal, according to another embodiment of the invention. FIG. 13 is a block diagram of the download device for the user terminal 10 to obtain the address information of the one or more file same as the Flash video in the corresponding multimedia servers under the assistance from the first network server 30′, according to another embodiment of the invention.

Similar to the abovementioned embodiment 3, as shown in FIG. 1, the user 1 uses the user terminal 10 to download a Flash video. And an HTTP-based multimedia server 20 of a content provider 2 on the Internet provides Internet users with this Flash video in the form of a FLV file, and the file name is FLV-1. The Internet browser on user terminal 10 of the user 1 is installed with a Flash player 101 for the content provider to which the FLV-1 belongs to. This Flash player 101 sends for example an HTTP-based download request for the FLV-1 in the way of for example active script, and this download request contains the URL information of the FLV-1 on the multimedia server 20. However, the URL address of the FLV-1 on the multimedia server 20 of the content provider is hidden. Those skilled in the art could understand that the invention is not limited by this scenario and can also be used for scenarios that the content provider provides address-hidden multimedia content of other types, and the user downloads the address-hidden multimedia content via other means.

In the present embodiment, the user terminal 10 comprises a downloading device 100′ of downloading multimedia contents to be downloaded from the network to the local user terminal, wherein, the downloading device 100′ comprises an obtainer 1001′ for address information, an obtainer 1002′ for network resource, and a downloading unit 1003′. The obtainer 1002′ for network resource further comprises an obtaining unit 10021′ for content address and a determining unit 10022′ for content address.

As shown in FIG. 12, firstly, the obtainer 1001′ for address information obtains the URL of the FLV-1 in the multimedia server 20 during the procedure that the Flash player 101 obtains the FLV-1 in the multimedia server 20. The specific method for obtaining is similar as that in obtainer 1001 for address information in embodiment 3, thus will not be described unnecessarily.

After the URL of the FLV-1 in the multimedia server 20 is obtained, the obtainer 1002′ for network resource obtains information related to multiple network resources comprising the same Flash video as FLV-1, according to the URL of the FLV-1 in the multimedia server 20. Wherein, in the present embodiment, the multiple network resources comprising the same Flash video as FLV-1 includes other multimedia servers and/or the multimedia server 20.

In a preferred embodiment, the obtainer 10021′ for content address obtains information related to multiple other multimedia servers comprising files with the same video content as FLV-1, under the assistance from the first network server 30′. As shown in FIG. 7, the user terminal 10 logically connects to the first network server 30′ via the Internet, and the user terminal 10 can communicate with the multiple other multimedia servers comprising files with the same video contents as FLV-1 via the Internet.

Preferably, the obtaining unit 10021′ for content address further comprises a sender 100211′ for address information and a receiver 100212′ for content address. The assisting download device 300′, in the first network server 30′, for assisting the user terminal to download the multimedia contents from the network to the user terminal with high speed comprises a receiver 3001′ for address information, an obtaining unit 3002′ for content information and a providing unit 3003′ for content information.

Firstly, the sender 100211′ for address information sends, to the first network server 30′, the URL of the FLV-1 in the multimedia server 20 obtained in the obtainer 1001′ for address information.

Then, the receiver 3001′ for address information of the first network server 30′ receives the URL of the FLV-1 in the multimedia server 20 from the user terminal 10.

Then, the obtaining unit 3002′ for content information obtains one or more content address information related to the URL, according to the URL of FLV-1 in the multimedia server 20. The content address information is for example the URLs of one or more certain files in the corresponding servers. In a preferred embodiment, a user terminal, have downloaded FLV-1 according to the URL of FLV-1 in the multimedia server 20, and fed back the MD5 check sum of the FLV-1 file together with the URL to the first network server 30′; And the first network server 30′ locally maintains the corresponding relationship between the URL of FLV-1 in multimedia server 20 and the URLs of one or more Flash video files with the same content in the corresponding servers, according to the same unique identification information, for example in a database. Then, the obtaining unit 3002′ for content information inquires all the maintained corresponding relationships, and obtains the one or more URLs corresponding to the URL of FLV-1 in the multimedia server 20. It should be noted that, however, since the content provider corresponding to the URL may modify or replace the file corresponding to the URL, which may cause that the URL may not correspond to the file FLV-1 in fact. However, the first network server 30′ can't update in real time the maintained corresponding relationship between this URL and the corresponding URLs automatically. Thus the one or more URLs obtained by the obtaining unit 3002′ for content information may include one or more URLs corresponding to the FLV-1 currently to be downloaded, or may include none corresponding to the FLV-1 currently to be downloaded.

In another embodiment, another network server maintains the corresponding relationship between the URL and the one or more corresponding URLs. Then the obtaining unit 3002′ for content information obtains the one or more corresponding URLs corresponding to the URL of FLV-1 in the multimedia server 20 by inquiring the other network server.

Then, the providing unit 3003′ for content information sends, to the user terminal 10, the one or more corresponding URLs corresponding to the URL of FLV-1 in the multimedia server 20 obtained by the obtaining unit 3002′ for content information.

After that, the receiver 100212′ for content address of user terminal 10 receives the one or more corresponding URLs corresponding to the URL of FLV-1 in the multimedia server 20.

The above procedure of interaction between the user terminal 10 and the first network server 30′ is shown by the path A′ in FIG. 7.

In a varied embodiment, before the current download, the user terminal 10 has downloaded the file FLV-1 according to the URL of FLV-1 in the multimedia server 20 and the URLs of one or more Flash video file with the same content in the corresponding servers. Then, the obtaining unit 10021′ for content address could inquire the locally maintained corresponding relationship between the URL of FLV-1 in multimedia sever 20 and other corresponding URLs, and obtain one or more URLs corresponding to the URL of FLV-1 in multimedia sever 20. However, it should be appreciated that since the content provider corresponding to the URL may modify the file corresponding to the URL, and the URL may not correspond to FLV-1 in fact. However, the user terminal 10 can't automatically update in real time the maintained corresponding relationship between this URL and the corresponding URLs. Thus the one or more corresponding URLs obtained by the obtaining unit 10021′ for content address may include one or more URLs corresponding to the FLV-1 currently to be downloaded, or may include none corresponding to the FLV-1 currently to be downloaded.

Then, the determining unit 10022′ for content address determines one or more URLs whose content of the corresponding file is the same as the FLV-1 to be downloaded, from the one or more corresponding URLs obtained by the obtaining unit 10021′ for content address, as the candidate URLs. Due to the above mention reason that the content provider may change the file FLV-1 corresponding to the URL, the FLV file downloaded according to the URL may be different from the currently requested file FLV-1 if the user terminal 10 doesn't validate the URL obtained by the obtaining unit 10021′ for content address. In the embodiment, the determining unit 10022′ for content address determines that multimedia servers 20′ and 20″ comprise files with the same content as FLV-1 currently requested, and thus determines the corresponding URLs as the candidate URLs.

After that, the downloading unit 1003′ downloads FLV-1 simultaneously from the multimedia servers 20′ and 20″, according to the candidate URLs of the multimedia servers 20′ and 20″ comprising the same Flash video as FLV-1, obtained by the obtaining unit 1002′ for network resource, as shown by the path D′ in FIG. 7. Meanwhile, the downloading unit 1003′ may also download from the multimedia server 20,the part of FLV-1 that isn't downloaded from the multimedia server 20′ and 20″, according to the URL of FLV-1 in the multimedia server 20 obtained by the obtainer 1001′ for address information, as shown in path D in FIG. 7. In this manner, the downloading of FLV-1 simultaneously from multiple network resources greatly increases the speed of downloading FLV-1. Finally, data downloaded from the multimedia server 20 are combined with the data downloaded from the multimedia servers 20′ and 20″ as the complete file FLV-1.

In a preferred embodiment, the downloading device 100′ of user terminal 10 further comprises a reporting unit 1004′. And the assisting download device 300′ of the first network server 30 further comprises a second receiver 3004′ for report and a managing unit 3005′ for content address.

In the process of downloading the file FLV-1, the reporting unit 1004′ reports, to the first network server 30′, the status information of the currently downloaded FLV-1. Wherein, the status information preferably comprises the status of downloading according to the one or more URLs corresponding to the URL of FLV-1 in the multimedia server 20 and/or the URL of FLV-1 in the multimedia server 20, and/or the MD5 check sum of the FLV-1.

After that, the second receiver 3004′ for report receives the status information of the currently downloaded FLV-1 reported by the user terminal 10 in the process of downloading the file FLV-1. Wherein, the status information preferably comprises the status of downloading according to the one or more URLs corresponding to the URL of FLV-1 in the multimedia server 20 and/or the URL of FLV-1 in the multimedia server 20, and/or the MD5 check sum of the FLV-1.

Then, the managing unit 3005′ for content address creates or updates the URLs corresponding to the URL of the FLV-1 in the multimedia server 20, according to the status of downloading according to the candidate URL and/or the URL of the FLV-1 in the multimedia server 20, reported by the user terminal 10. Specifically, in case that the user terminal 10 is the first user that downloads this file from one certain URL, the user terminal 10 provides the first network server 30′ with this URL together with the MD5 check sum of the file FLV-1, and the managing unit 3005′ for content address co-relates all URLs with the same MD5 check sums; and in case that the content provider corresponding to the URL modifies the file FLV-1 corresponding to the URL as previously mentioned and causes that the file FLV-1 corresponding to this URL is false , and the user terminal 10 couldn't download the FLV-1 according to this URL, the user terminal 10 notifies the first network server 30′ of this false status, then the managing unit 3005′ for content address deletes the relationship between this false URL and other URLs.

Although the figures and the above disclosures elucidate the invention, it should be noted that these elucidation is provided by way of describing and exemplifying, instead of limiting. The invention is not limited by the above embodiments.

Those ordinary skilled in the art could understand and implement modifications to the disclosed embodiments, through studying the description, drawings and appended claims. All such modifications which do not depart from the spirit of the invention are intended to be included within the scope of the appended claims. The word “ comprising” does not exclude the presence of elements or steps not listed in a claim or in the description. The word “ a” or “ an” preceding an element does not exclude the presence of a plurality of such elements. In the practice of present invention, several technical features in the claim can be embodied by one component. In the claims, any reference signs placed between parentheses shall not be construed as limiting the claim.

1. A downloading method of downloading multimedia contents to be downloaded from the network to the local user terminal, wherein a predetermined multimedia server comprises the multimedia contents to be downloaded, the address information of the multimedia contents to be downloaded in the multimedia server is hidden, the method comprises the steps of:
i. obtaining address information of the multimedia contents to be downloaded in the predetermined multimedia server, when a multimedia player of the user terminal obtains the multimedia contents to be downloaded from the predetermined multimedia server;
ii. obtaining information related to a plurality of network resources comprising the same multimedia contents as the multimedia contents to be downloaded, according to the address information of the multimedia contents to be downloaded in the predetermined multimedia server; and
iii. downloading the multimedia contents to be downloaded, according to the information related to the plurality of network resources.

2. The downloading method as claimed in of claim 1, wherein the step i further comprises:
obtaining corresponding request for at least one content sent from the user terminal and obtaining information related to the event generated by the request for the multimedia content to be downloaded sent from the multimedia player, when the multimedia player requests for the multimedia contents to be downloaded in the predetermined multimedia server, wherein corresponding request for at least one content comprises request for the multimedia contents to be downloaded, the request for the multimedia contents to be downloaded comprising address information of the multimedia contents to be downloaded on the predetermined multimedia server;
determining the request, associated with the obtained information related to the event, in the obtained at least one request as an associated request; and
obtaining the address information of the multimedia contents to be downloaded in the predetermined multimedia server according to the associated request.

3. The downloading method of claim 1, wherein the step ii further comprises:
ii1. obtaining at least one content identification information corresponding to the address information of the multimedia contents to be downloaded in the predetermined multimedia server, according to the address information of the multimedia contents to be downloaded in the predetermined multimedia server;
ii2. determining the content identification information whose corresponding content is the same as the multimedia contents to be downloaded, in each content identification information, as the candidate content identification information, according to the at least one content identity information;
ii3. obtaining the information related to other user terminal nodes that comprise the piece of the contents corresponding to the candidate content identification information, according to the candidate content identification information; and
the step iii further comprises:
downloading the multimedia contents to be downloaded from the other user terminal nodes based on P2P technology, according to the information related to other user terminal nodes.

4. The downloading method of claim 3, wherein the step ii3 comprises:
sending, to a predetermined second network server, the candidate content identification information and the node related information of the user terminal; and
receiving, from the second network server, the information related to other user terminal node that comprises the piece of the contents same as the multimedia contents to be downloaded.

5. The downloading method of claim 4, wherein the network resource comprises the other user terminal node or the predetermined multimedia server.

6. The downloading method of claim 3, wherein the step ii1 comprises:
sending, to a predetermined first network server, the address information of the multimedia contents to be downloaded in the predetermined multimedia server; and
receiving, from the first network server, at least one content identification information corresponding to the address information of the multimedia contents to be downloaded in the predetermined multimedia server.

7. The downloading method of claim 3, wherein the method further comprises:
v. reporting, to the first network server, the status information of the currently obtained multimedia contents to be downloaded, in the process of downloading the multimedia contents to be downloaded, wherein the status information comprises the identity information of the multimedia contents to be downloaded.

8. The downloading method of claim 1, wherein the step ii comprises:
ii1′. obtaining at least one content address information related to the address information of the multimedia contents to be downloaded in the predetermined multimedia server, according to the address information of the multimedia contents to be downloaded in the predetermined multimedia server, wherein the content address information comprises the address information of the corresponding contents on the corresponding content server;
ii2′. determining at least one content address information whose corresponding contents are the same as the multimedia contents to be downloaded, in each content address information, as the candidate content address information, according to the at least one content address information; and
the step iii further comprises:
downloading the multimedia contents to be downloaded from the corresponding content server, according to the at least one candidate content address information.

9. The downloading method of claim 8, wherein the network resources comprise content server or predetermined multimedia servers corresponding to the at least one candidate content address information.

10. The downloading method of claim 8, wherein the step ii1′ further comprises:
sending the address information of the multimedia contents to be downloaded in the multimedia server to a predetermined first network server; and
receiving, from the first network server, at least one content address information related to the address information of the multimedia contents to be downloaded in the multimedia server.

11. The downloading method of claim 8, wherein the downloading method further comprises:
v. reporting, to the first network server, the status information of the currently obtained multimedia contents to be downloaded in the process of downloading the multimedia contents to be downloaded, wherein the status information comprises the status of the downloads of the user terminal according to the at least one content address information and/or the address information of the multimedia contents to be downloaded on the predetermined multimedia server.

12. An assisting download method, in a first network server, for assisting the user terminal to download the multimedia contents to be downloaded from the network to the user terminal with high speed, wherein the predetermined multimedia server comprises the multimedia contents to be downloaded, the address information of the multimedia contents to be downloaded on the predetermined multimedia server is hidden, the assisting download method comprises:
o. receiving the address information of the multimedia contents to be downloaded in the predetermined multimedia server from the user terminal;
p. obtaining the information related to the multimedia contents according to the address information of the multimedia contents to be downloaded on the predetermined multimedia server; and
q. providing the information related to the multimedia contents to the user terminal.

13. The assisting download method of claim 12, wherein the step p comprises:
obtaining at least one content identification information corresponding to the address information of the multimedia contents to be downloaded on the predetermined multimedia server, according to the address information of the multimedia contents to be downloaded on the predetermined multimedia server.

14. The assisting download method of claim 13, wherein the method further comprises:
s. receiving the status information of the currently obtained multimedia contents to be downloaded reported by the user terminal during the process of obtaining the multimedia contents to be downloaded, wherein the status information comprises identity information of the multimedia contents to be downloaded that is downloaded by the user terminal; and
t. creating or updating the content identification information corresponding to the address information of the multimedia contents to be downloaded on the predetermined multimedia server, according to the content identification information of the multimedia contents to be downloaded reported by the user terminal.

15. The assisting download method of claim 12, wherein the step p further comprises:
obtaining at least one content address information related to the address information of the multimedia contents to be downloaded in the predetermined multimedia server, according to the address information of the multimedia contents to be downloaded in the predetermined multimedia server, wherein the content address information comprises the address information of the corresponding contents on the corresponding content server.

16. The assisting download method of claim 15, wherein the step p further comprises:
s′. receiving the status information of the currently obtained multimedia contents to be downloaded reported by the user terminal during the process of obtaining the multimedia contents, wherein the status information comprises the status of the download of the user terminal according to the at least one content address information and/or the address information of the multimedia contents to be downloaded on the predetermined multimedia server; and
t′. creating or updating the content address information corresponding to the address information of the multimedia contents to be downloaded on the predetermined multimedia server, according to status information of downloading according to the at least one content address information and/or the address information of the multimedia contents to be downloaded on the predetermined multimedia server.

17. An assisting downloading method, in a second network server, for assisting a user terminal to download multimedia contents to be downloaded from the network with high speed, wherein a predetermined multimedia server comprises the multimedia contents to be downloaded, and the address information of the multimedia contents to be downloaded in the predetermined multimedia server is hidden, the assisting downloading method comprises:
I. receiving, from the user terminal, candidate content identification information and the node related information of the user terminal, wherein contents corresponding to the candidate content identification information are the same as the multimedia contents to be downloaded;
II. obtaining the information related to other user terminal nodes that have piece of the contents corresponding to the candidate content identification information, according to the candidate content identification information; and
III. sending, to the user terminal, the information related to other user terminal nodes that have piece of the contents corresponding to the candidate content identification information.

18. A downloading device for downloading multimedia contents to be downloaded from the network to the local user terminal, wherein a predetermined multimedia server comprises the multimedia contents to be downloaded, the address information of the multimedia contents to be downloaded in the multimedia server is hidden, the device comprises:
an obtainer for address information, for obtaining address information of the multimedia contents to be downloaded in the predetermined multimedia server, when a multimedia player of the user terminal obtains the multimedia contents to be downloaded from the predetermined multimedia server;
an obtainer for network resource, for obtaining information related to a plurality of network resources comprising the same multimedia contents as the multimedia contents to be downloaded, according to the address information of the multimedia contents to be downloaded in the predetermined multimedia server; and
a downloading unit, for downloading the multimedia contents to be downloaded, according to the information related to the plurality of network resources.

19. The downloading device as claimed in of claim 18, wherein the obtainer for address information further comprises:
a first obtaining unit, for obtaining corresponding request for at least one content sent from the user terminal and obtaining information related to the event generated by the request for the multimedia content to be downloaded sent from the multimedia player, when the multimedia player requests for the multimedia contents to be downloaded in the predetermined multimedia server, wherein corresponding request for at least one content comprises request for the multimedia contents to be downloaded, the request for the multimedia contents to be downloaded comprising address information of the multimedia contents to be downloaded on the predetermined multimedia server;
a first determining unit, for determining the request, associated with the obtained information related to the event, in the obtained at least one request as an associated request; and
a second obtaining unit, for obtaining the address information of the multimedia contents to be downloaded in the predetermined multimedia server according to the associated request.

20. The downloading device of claim 18, wherein said obtainer for network resource further comprises:
an obtaining unit for content identification, for obtaining at least one content identification information corresponding to the address information of the multimedia contents to be downloaded in the predetermined multimedia server, according to the address information of the multimedia contents to be downloaded in the predetermined multimedia server;
a determining unit for content identification, for determining the content identification information whose corresponding content is the same as the multimedia contents to be downloaded, in each content identification information, as the candidate content identification information, according to the at least one content identity information;
an obtaining unit for node information, for obtaining the information related to other user terminal nodes that comprise the piece of the contents corresponding to the candidate content identification information; and
the downloading unit is further used for downloading the multimedia contents to be downloaded from the other user terminal nodes based on P2P technology, according to the information related to other user terminal nodes.

21. The downloading device of claim 20, wherein the obtaining unit for node information comprises:
a sender for content identification, for sending, to a predetermined second network server, the candidate content identification information and the node related information of the user terminal; and
a receiver for node information, for receiving, from the second network server, the information related to other user terminal node that comprises the piece of the contents same as the multimedia contents to be downloaded.

22. The downloading device of claim 20, wherein the network resource comprises the other user terminal node or the predetermined multimedia server.

23. The downloading device of claim 20, wherein the obtaining unit for content identification further comprises:
a sender for address information, for sending, to a predetermined first network server, the address information of the multimedia contents to be downloaded in the predetermined multimedia server; and
a receiver for content identification, for receiving, from the first network server, at least one content identification information corresponding to the address information of the multimedia contents to be downloaded in the predetermined multimedia server.

24. The downloading device of claim 20, further comprising:
a first reporting unit, for reporting, to the first network server, the status information of the currently obtained multimedia contents to be downloaded, in the process of downloading the multimedia contents to be downloaded, wherein the status information comprises the identity information of the multimedia contents to be downloaded.

25. The downloading device of claim 18, wherein the obtainer for network resource comprises:
an obtaining unit for content address, for obtaining at least one content address information related to the address information of the multimedia contents to be downloaded in the predetermined multimedia server, according to the address information of the multimedia contents to be downloaded in the predetermined multimedia server, wherein the content address information comprises the address information of the corresponding contents on the corresponding content server;
a determining unit for content address, for determining at least one content address information whose corresponding contents are the same as the multimedia contents to be downloaded, in each content address information, as the candidate content address information, according to the at least one content address information; and
the downloading unit is for downloading the multimedia contents to be downloaded from the corresponding content server, according to the at least one candidate content address information.

26. The downloading device of claim 25, wherein the network resources comprise content server and/or predetermined multimedia servers corresponding to the at least one candidate content address information.

27. The downloading device of claim 25, wherein the obtaining unit for content address comprises:
a sender for address information, for sending the address information of the multimedia contents to be downloaded in the multimedia server to a predetermined first network server; and
a receiver for content address, for receiving, from the first network server, at least one content address information related to the address information of the multimedia contents to be downloaded in the multimedia server.

28. The downloading device of claim 25, further comprising:
a second reporting unit, for reporting, to the first network server, the status information of the currently obtained multimedia contents to be downloaded in the process of downloading the multimedia contents to be downloaded, wherein the status information comprises the status of the downloads of the user terminal according to the at least one content address information and/or the address information of the multimedia contents to be downloaded in the predetermined multimedia server.

29. An assisting download device, in a first network server, for assisting the user terminal to download the multimedia contents to be downloaded from the network to the user terminal with high speed, wherein the predetermined multimedia server comprises the multimedia contents to be downloaded, the address information of the multimedia contents to be downloaded on the predetermined multimedia server is hidden, the assisting download device comprises:
a receiver for address information, for receiving the address information of the multimedia contents to be downloaded in the predetermined multimedia server from the user terminal;
an obtaining unit for content information, for obtaining the information related to the multimedia contents according to the address information of the multimedia contents to be downloaded on the predetermined multimedia server; and
a providing unit for content information, for providing the information related to the multimedia contents to the user terminal.

30. The assisting download device of claim 29, wherein the obtaining unit for content information is further used for obtaining at least one content identification information corresponding to the address information of the multimedia contents to be downloaded on the predetermined multimedia server, according to the address information of the multimedia contents to be downloaded on the predetermined multimedia server.

31. The assisting download device of claim 30, further comprising:
a first receiver for report, for receiving the status information of the currently obtained multimedia contents to be downloaded reported by the user terminal during the process of obtaining the multimedia contents to be downloaded, wherein the status information comprises identity information of the multimedia contents to be downloaded that is downloaded by the user terminal; and
a managing unit for content identification, for creating or updating the content identification information corresponding to the address information of the multimedia contents to be downloaded on the predetermined multimedia server, according to the content identification information of the multimedia contents to be downloaded reported by the user terminal.

32. The assisting download method of claim 29, wherein the obtaining unit for content information is further for obtaining at least one content address information related to the address information of the multimedia contents to be downloaded in the predetermined multimedia server, according to the address information of the multimedia contents to be downloaded in the predetermined multimedia server, wherein the content address information comprises the address information of the corresponding contents on the corresponding content server.

33. The assisting download device of claim 32, further comprising:
a second receiver for report, for receiving the status information of the currently obtained multimedia contents to be downloaded reported by the user terminal during the process of obtaining the multimedia contents, wherein the status information comprises the status of the download of the user terminal according to the at least one content address information and/or the address information of the multimedia contents to be downloaded on the predetermined multimedia server; and
a managing unit for content address, for creating or updating the content address information corresponding to the address information of the multimedia contents to be downloaded on the predetermined multimedia server, according to status information of downloading according to the at least one content address information and/or the address information of the multimedia contents to be downloaded on the predetermined multimedia server.

34. An assisting downloading device, in a second network server, for assisting a user terminal to download multimedia contents to be downloaded from the network with high speed, wherein a predetermined multimedia server comprises the multimedia contents to be downloaded, and the address information of the multimedia contents to be downloaded in the predetermined multimedia server is hidden, the assisting downloading device comprises:
a receiver, for receiving, from the user terminal, candidate content identification information and the node related information of the user terminal, wherein contents corresponding to the candidate content identification information are the same as the multimedia contents to be downloaded;
an obtaining unit for node information, for obtaining the information related to other user terminal nodes that have piece of the contents corresponding to the candidate content identification information, according to the candidate content identification information; and
a sender for node information, for sending, to the user terminal, the information related to other user terminal nodes that have piece of the contents corresponding to the candidate content identification information.

35. The downloading device of claim 18, wherein the user terminal comprises a downloading device.

36. The assisting downloading device of claim 29, wherein the network server comprises an assisting download device.

37. The assisting downloading device of claim 34, wherein the network server comprises an assisting downloading device.

38. The downloading method of claim 1, wherein the method is configured to be executed by one or more computers.
